(19) United States
(12) Patent Application Publication
(10) Pub. No.: US 2009/0293646 A1
(43) Pub. Date: Dec. 3, 2009

(54) SYSTEM AND METHOD FOR OPTICAL DETECTION OF AEROSOLS

(76) Inventors: Robert Johnson, Federal Way, WA (US); Richard DeFreez, Azalea, OR (US)

Correspondence Address: LAW OFFICES OF RONALD M ANDERSON, 600 108TH AVE, NE, SUITE 507, BELLEVUE, WA, 98004, US

(21) Appl. No.: 12/298,744

(22) PCT Filed: Apr. 26, 2007
(86) PCT No.: PCT/US07/67554

§ 371 Date: Jan. 23, 2009

Related U.S. Application Data
(63) Continuation of application No. 11/380,629, filed on Apr. 27, 2006, now abandoned.
(60) Provisional application No. 60/714,007, filed on Sep. 2, 2005.

(51) Int. Cl. G01N 1/22; G01N 21/00

(52) U.S. Cl. 73/863.22; 356/437; 73/863.23

(57) ABSTRACT

A detector for optically detecting biological aerosols in a sample volume using non-imaging optical components (NIOCs) includes a light source configured to stimulate bio-fluorescence of tryptophan or nicotinamide adenine dinucleotide. A first NIOC is disposed adjacent to the light source and is configured to direct light away from the first light source. A detector is configured to detect bio-fluorescence associated with biological aerosols, and a second NIOC is disposed adjacent to the detector and is configured to direct light toward the first detector. In at least one embodiment, each NIOC comprises a compound parabolic collector. In one embodiment, the volume is disposed between the first and second NIOC, and in other embodiments, the volume is disposed distally of both NIOCs. To facilitate volume production, the NIOC can be formed as an integral structure. Preferably, the sample is a volume of a gaseous fluid, such as air.

### BACKGROUND

Detecting biological aerosols is of concern in a number of civilian and military contexts. There is growing recognition that biological agents could be employed in a terrorist attack. The most effective response to biohazards depends on detecting them as early as possible. Any delay can result in further spreading of the biological agents among the population and over a wider geographical area. Early detection will enable containment of the threat.

Detection requires characterizing biological aerosols. Characterization of biological aerosols can be performed while the aerosols are airborne, or after the biological aerosols are extracted from the air and deposited onto a solid surface (or into a liquid) for subsequent physical or chemical analysis. It would be particularly desirable to provide techniques for detecting biological aerosols while the biological aerosols are entrained in air, so that additional mechanisms are not required to extract the biological aerosols from an air stream before analysis.

Various optical methods have been used to detect biological aerosols. For example, tryptophan and nicotinamide adenine dinucleotide (NADH) are present in some concentration in most biological agents. When illuminated with light of an appropriate wavelength, tryptophan, NADH and other bio-chemical species autofluoresce with a characteristic signature. The detection of such optical signatures is thus indicative of the possible presence of biological aerosols. Prior art optical detection systems include complicated imaging optics and a plurality of discrete reflective and/or refractive components, each of which must be mounted and aligned individually, increasing the complexity and cost of such detection systems. It would be desirable to provide optical-based detection systems for biological aerosols entrained in air that have reduced part counts, reduced alignment sensitivity, and reduced assembly time. The resulting cost and time savings should enable such optical detection systems to be widely deployed if a biological agent threat is suspected.

### SUMMARY

A first aspect of the concepts disclosed herein is directed to an apparatus configured to facilitate optical detection of biological aerosols in air. The apparatus includes a first non-imaging optical component configured to direct light to be used to illuminate a sample, and a second non-imaging optical component configured to direct light from the sample to a detector configured to generate a signal indicative of the presence of biological aerosols in the sample. Significantly, in one exemplary embodiment, at least a portion of the first non-imaging optical component and at least a portion of the second non-imaging optical component are implemented as a monolithic or integrated optical structure. In a particularly preferred implementation, portions of the first non-imaging optical component and portions of the second non-imaging optical component are implemented on a first monolithic optical structure, while other portions of the first and second non-imaging optical components are implemented on a second monolithic optical structure, such that when the first and second monolithic optical structures are coupled together in a facing relationship, the first and second non-imaging optical components are completed. Preferably, at least one of the first non-imaging optical component and the second non-imaging optical component is a compound parabolic collector.

In at least one exemplary embodiment, the monolithic optical structure is fabricated using injection molding techniques. Portions of the monolithic optical structure corresponding to the first and second non-imaging optical components are preferably coated with a reflective material.

The apparatus preferably includes a light source configured to stimulate a biological aerosol to emit light, the light source being coupled with the first non-imaging optical component. In a particularly preferred embodiment, the light source is implemented using a light emitting diode (LED). The apparatus also preferably includes a detector configured to detect the light emitted from the biological aerosol, the detector being coupled with the second non-imaging optical component.

Yet another aspect of the concepts disclosed herein is directed to an apparatus for optically detecting biological aerosols in air. This apparatus includes a light source configured to stimulate a biological aerosol to emit light, a first non-imaging optical component configured to direct light away from the light source, a detector configured to detect the light emitted from the biological aerosol, and a second non-imaging optical component configured to direct light toward the detector.

Preferably, at least a portion of the first non-imaging optical component and at least a portion of the second non-imaging optical component are implemented as a monolithic structure. It is also preferred to implement at least one of the first non-imaging optical component and the second non-imaging optical component using a compound parabolic collector. The light source can be beneficially implemented as an LED.

Still another aspect of the presently disclosed novel concept is an apparatus for optically detecting biological aerosols in air. The apparatus in this implementation includes a light source configured to stimulate a biological aerosol to emit light, a detector configured to detect the light emitted from the biological aerosol, a first monolithic optical structure incorporating a plurality of first surface features, and a second monolithic optical structure incorporating a plurality of second surface features. When the first monolithic optical structure and the second monolithic optical structure are disposed in a facing relationship, the plurality of the first surface features and the plurality of second surface features define a plurality of non-imaging optical components, which include at least a first non-imaging optical component disposed adjacent to the light source and being configured to direct light to be used to stimulate the biological aerosol away from the light source, and a second non-imaging optical component configured to direct light emitted from the biological aerosol toward the detector.

Preferably, at least one of the first non-imaging optical component and the second non-imaging optical component comprises a compound parabolic collector. Each monolithic optical structure can be formed from a polymer, and each surface feature defining one of the plurality of non-imaging optical components is preferably coated with a reflective material.

The first monolithic optical structure can incorporate a plurality of third surface features, while the second monolithic optical structure can incorporate a plurality of fourth surface features, such that when the first monolithic optical structure and the second monolithic optical structure are disposed in a facing relationship, the plurality of third surface features and the plurality of fourth surface features cooperate to provide support for at least one additional component, such as at least one of a dichroic beam splitter, an emitter filter, and emission filter.

A related apparatus for optically detecting biological aerosols in air, also disclosed in detail herein, includes a first LED configured to stimulate bio-fluorescence of tryptophan, a first compound parabolic collector disposed adjacent to the first LED (the first compound parabolic collector being configured to direct light away from the first LED), a second LED configured to stimulate bio-fluorescence of nicotinamide adenine dinucleotide (NADH), a second compound parabolic collector disposed adjacent to the second LED (the second compound parabolic collector being configured to direct light away from the second LED), a first detector configured to detect bio-fluorescence associated with tryptophan, a third compound parabolic collector disposed adjacent to the first detector (the third compound parabolic collector being configured to direct light toward the first detector), a second detector configured to detect bio-fluorescence associated with NADH, and a fourth compound parabolic collector disposed adjacent to the second detector (the fourth compound parabolic collector being configured to direct light toward the second detector).

Still other embodiments of the apparatus further include a virtual impactor to separate a gaseous fluid flow in which biological particles are entrained into a major flow (that includes a minor portion of biological particles above a predetermined size), and a minor flow (that includes a major portion of the biological particles above the predetermined size). The minor flow is directed onto the substrate by means of an impactor, such that biological particles entrained in the minor flow are deposited on the substrate. It should be recognized that the incorporation of a virtual impactor is not required, and other embodiments will be implemented without a virtual impactor.

In still another embodiment, the apparatus is substantially similar to those described above, except that the apparatus includes an inlet pre-filter configured upstream of the impactor and virtual impactor (when implemented). An inlet pre-filter is a device that performs one or more of the following functions: (a) removes over-sized particles that are too large to be of interest (for example, those greater than 10 microns in diameter), (b) rejects or removes rain, snow and other precipitation, (c) restricts insects from crawling or flying into the apparatus, and (d) rejects or removes other flying debris.

Still another aspect of the inventive concept disclosed herein is directed to a method for optically detecting biological aerosols. The method comprises the steps of directing light away from a light source configured to stimulate the biological particles to emit light using a first non-imaging optical component. The light directed away from the light source is used to illuminate the biological particles, one at a time as they flow though the beam of light provided by the light source, thereby stimulating the biological particles to emit light. Light emitted from each biological particle is directed to a detector using a second non-imaging optical component.

Still other embodiments of the method further comprise the step of using a virtual impactor (disposed upstream of the optical detector described above) to separate a gaseous fluid flow in which biological particles are entrained into a major flow (that includes a minor portion of biological particles above a predetermined size) and a minor flow (that includes a major portion of the biological particles above the predetermined size.) The minor flow is directed into the optical detector.

In still another embodiment, the method is substantially similar to that described above, except that the method includes using an inlet pre-filter disposed upstream of the virtual impactor (if the virtual impactor is included), to filter the gaseous fluid before optically detecting the presence of biological material.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 schematically illustrates a first embodiment of an optical biological aerosol detector based on the use of non-imaging optical components;

FIG. 2 schematically illustrates a (Prior Art) non-imaging optical component for use in the optical biological aerosol detector of FIG. 1, commonly referred to as a compound parabolic collector (CPC);

FIG. 3 schematically illustrates how four CPCs can be combined to achieve the optical biological aerosol detector of FIG. 1;

FIG. 4 schematically illustrates how the optical biological aerosol detector of FIGS. 1 and 3 can be implemented using injection molding techniques;

FIG. 5 schematically illustrates a second embodiment of an optical biological aerosol detector based on the use of non-imaging optical components;

FIG. 6 schematically illustrates how a portion of the optical biological aerosol detector of FIG. 5, including the non-imaging optical components, can be implemented using injection molding techniques;

FIG. 7A is an isometric view of another exemplary embodiment of an optical aerosol detector based on the use of non-imaging optical components;

FIG. 7B schematically illustrates yet another exemplary embodiment of an optical aerosol detector based on the use of non-imaging optical components, like the optical aerosol detector of FIG. 7A;

FIGS. 8A and 8B schematically illustrate LED packages that can be used as a light source for the optical aerosol detectors disclosed herein;

FIG. 9 is a schematic view of a virtual impactor;

FIG. 10 is a block diagram of the components of an exemplary optical biological aerosol detection system;

FIG. 11A schematically illustrates yet another embodiment of an optical bioaerosol detector based on the use of non-imaging optical components;

FIG. 11B is a functional block diagram illustrating how a controller is logically coupled to various components of the optical bioaerosol detector of FIG. 11A;

FIG. 11C schematically illustrates how a portion of the optical bioaerosol detector of FIG. 11A including non-imaging optical components can be implemented as a monolithic structure suitable for fabrication using injection molding techniques;

FIG. 12 schematically illustrates yet another embodiment of an optical bioaerosol detector based on the use of non-imaging optical components, which includes two primary components including monolithic structures, an illumination chamber component and a detection flower component;

FIG. 13 schematically illustrates the illumination chamber component and the detection flower component of the optical bioaerosol detector of FIG. 12;

FIGS. 14 and 15 schematically illustrate a first monolithic structure used to implement the illumination chamber component of the optical bioaerosol detector of FIG. 12;

FIG. 16 schematically illustrates the elliptical and hemispherical reflectors employed in the illumination chamber component of the optical bioaerosol detector of FIG. 12;

FIG. 17 schematically illustrates an exemplary technique to introduce light from an LED into a sample volume in the illumination chamber component of the optical bioaerosol detector of FIG. 12;

FIG. 18 schematically illustrates details relating to the introduction of a gaseous fluid potentially including biological particles into the illumination chamber component of the optical bioaerosol detector of FIG. 12;

FIG. 19 schematically illustrates a first monolithic structure used to implement the detection flower component of the optical bioaerosol detector of FIG. 12;

FIG. 20 schematically illustrates an illumination chamber component configuration in which a reflector directing light from light sources into the illumination chamber is partially disposed within the illumination chamber; and

FIG. 21 schematically illustrates an illumination chamber component configuration in which no elements related to directing light from light sources into the illumination chamber are disposed within the illumination chamber, minimizing noise from stray light.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. A core feature of the concepts disclosed herein is optically detecting biological materials using non-imaging optics. While prior art optical biological detectors have used discrete optical imaging components that must be mounted and aligned individually, none have replaced imaging components with non-imaging components, nor integrated portions of the optical system into a monolithic structure. The novel approach disclosed herein opens up the opportunity to exploit high volume manufacturing methods, such as injection molding the detector. In addition, features such as filter and detector mounts can be incorporated into such integrated structures, reducing part count, component alignment sensitivity, and assembly time, all resulting in cost and time savings.

In particular, it should be recognized that while the exemplary embodiments discussed in detail below are generally referred to as biological aerosol detectors, the concept of optically detecting biological materials using non-imaging components can be applied to any sample, not simply to samples of biological aerosols. While one aspect of the concepts disclosed herein is the use of non-imaging optics for detecting the presence of biological materials in a sample of gaseous fluid (such as air), it must be recognized that the concepts disclosed herein (i.e., the use of non-imaging optics to detect the presence of biological materials) can be used to detect the presence of biological materials in other types of samples and are not limited to the detection of biological materials in a gaseous fluid.

The term “biological aerosol” as used herein is intended to refer to a sample of gaseous fluid, such as air, in which biological materials (such as biological particles) are suspended or entrained.

### Exemplary Optical Biological Detector Using Non-Imaging Optical Components

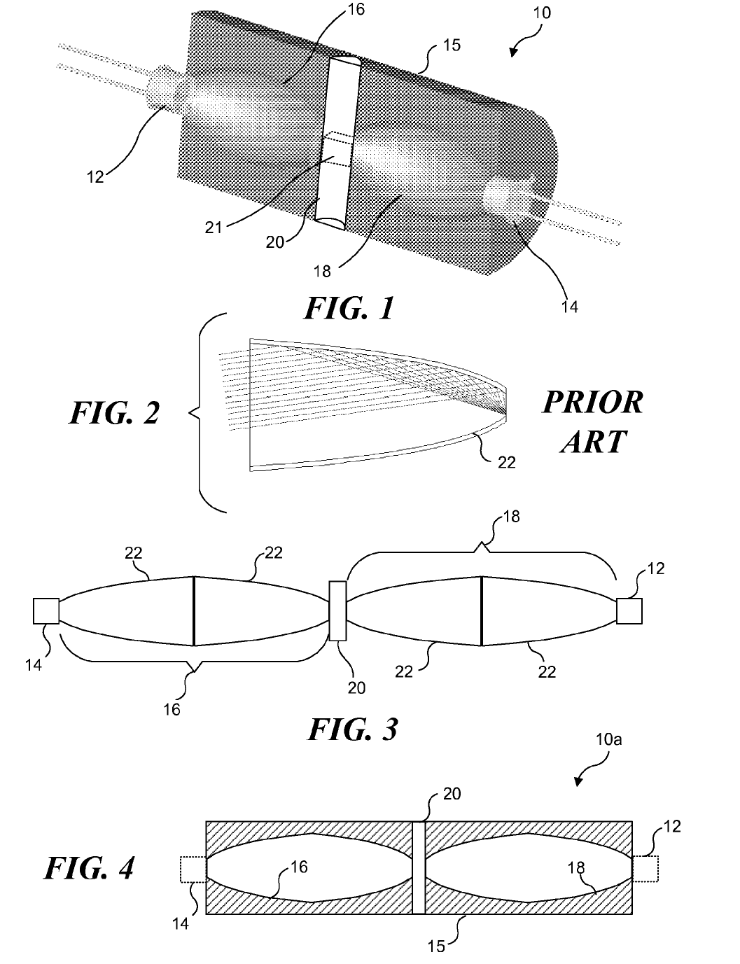

FIG. 1 schematically illustrates a first exemplary embodiment of an optical biological aerosol detector 10 based on the use of non-imaging optical components. Optical biological aerosol detector 10 includes a light source 12, a non-imaging optical component 16, an aerosol flow path 20, a portion of which comprises a sample volume 21, a non-imaging optical component 18, a detector 14, and a body 15. It should be recognized that FIG. 1 shows only one half of non-imaging optical component 16, non-imaging optical component 18, and body 15, to facilitate the viewing of internal details. A complete optical biological aerosol detector would include a mirror image of the portions of non-imaging optical component 16, non-imaging optical component 18, and body 15 relative to the view shown in FIG. 1.

Light source 12 is configured to emit light having a wavelength known to induce bio-fluorescence in biological materials. Those of ordinary skill in the art will recognize that both tryptophan and NADH autofluoresce with a characteristic signature when stimulated using light of an appropriate wavelength. While many different types of light sources can be employed, particularly preferred embodiments will utilize LED light sources. LEDs emitting light in a wavelength around 280 nm can be employed for the excitation of tryptophan, while LEDs emitting light in a wavelength around 360 nm can be employed for the excitation of NADH. Further research in the excitation of tryptophan and NADH using LED light sources is likely to provide additional alternative wavelengths that may be employed for this purpose.

Non-imaging optical component 16 is configured to direct light away from light source 12, and generally toward sample volume 21, which is preferably implemented as a fluid passage configured to enable a fluid (potentially including biological material) to be continually introduced into and flowing through the sample volume (i.e., as a flow of fluid). Although the detectors disclosed herein can be configured to operate in a batch mode, wherein a fluid sample is introduced into the sample volume, analyzed, and removed to enable an additional fluid sample to be introduced into the sample volume at a later time, in an exemplary embodiment, a flow of fluid will be introduced into the sample volume at a rate selected to enable substantially continuous detection to be achieved. Those of ordinary skill in the art will readily recognize that the flow rate will be a function of the specific light sources and the characteristics of the detectors employed. While not specifically shown in FIG. 1, it should be recognized that additional mechanisms, such as pumps, fans or blowers, can be employed to achieve a continuous flow of fluid through the sample volume. Furthermore, a vacuum can be applied to one side of the sample volume, to continuously draw fluid into the sample volume.

In one exemplary embodiment, the fluid is a gaseous fluid, such as air. However, the principles disclosed herein can be used with liquid samples, so long as the liquid is substantially optically transparent to the wavelengths of light emitted by the light source that are required to stimulate the fluorescence of biological materials contained within the liquid, and substantially optically transparent to the wavelengths of light emitted by the stimulated biological materials. If the liquid in the sample (or other materials contained within the sample) absorbs the light emitted by the light source and required to stimulate the fluorescence of the biological materials, or if the liquid in the sample (or other materials contained within the sample) absorbs the light emitted by the stimulated biological materials, performance of the optical biological detector will be impaired. To increase the likelihood of light from the light source reaching a biological material in the sample, it is desirable for the sample volume to have a cross-sectional size and shape that generally corresponds to an exit aperture of non-imaging optical component 16 (as well as an entrance aperture of non-imaging optical component 18).

FIG. 2 schematically illustrates a CPC 22, which represents a particularly preferred type of a Prior Art non-imaging optical component for use in the optical biological aerosol detector of FIG. 1. FIG. 3 schematically illustrates how four CPCs can be combined to achieve the optical biological aerosol detector of FIG. 1A. Two CPCs are placed end-to-end to achieve non-imaging optical component 16, and two additional CPCs are similarly placed end-to-end to achieve non-imaging optical component 18.

FIG. 4 schematically illustrates how the optical biological aerosol detector of FIGS. 1 and 3 can be implemented using injection molding techniques. Body 15 is formed from a polymer material using injection molding techniques, such that non-imaging optical components 16 and 18, as well as sample volume 20, are defined by volumes disposed within body 15. The inner surfaces of these volumes can be coated with a reflective material, such as a metallic film. To achieve a functional optical biological aerosol detector, a light source and a detector are coupled to openings formed in the injected molded body (such openings being proximate to light source 12 and detector 14), as well as the structures discussed above required to introduce a flow of fluid into the sample volume.

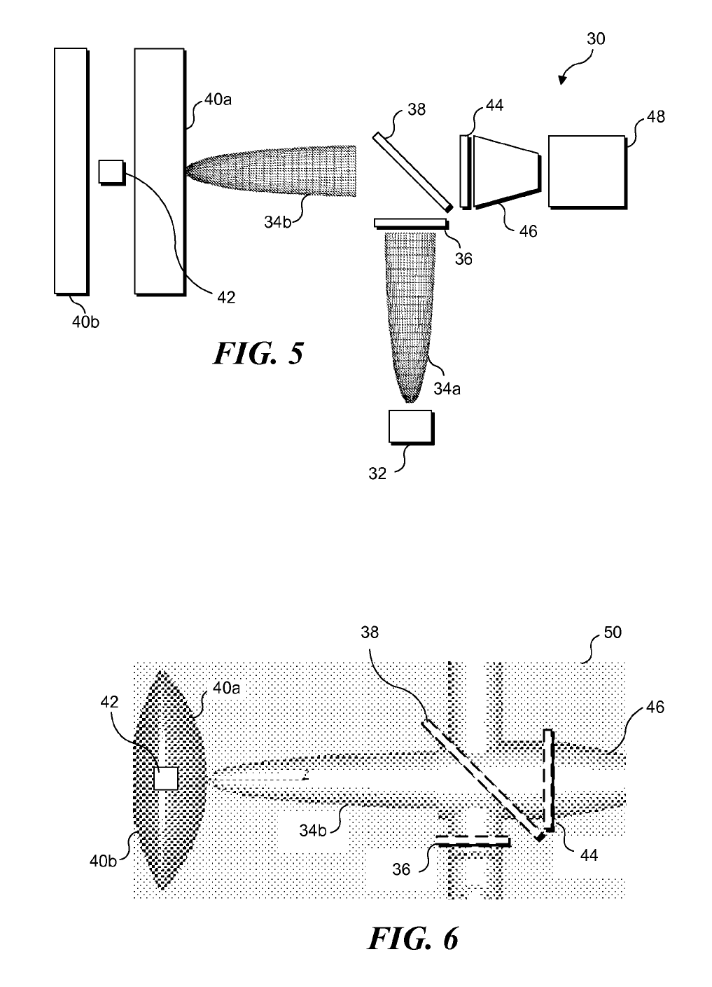

FIG. 5 schematically illustrates a second embodiment of an optical biological aerosol detector 30, also based on the use of non-imaging optical components. Optical biological aerosol detector 30 includes a light source 32 and a CPC 34a configured to collect radiation emitted from light source 32, and to convert the collected radiation into a slowly diverging beam, to be passed through an exciter filter 36. Light passing through exciter filter 36 encounters a beam splitter 38. The beam splitter diverts a portion of the light towards a CPC 34b, which is configured to condense the light received from the beam splitter and to direct the condensed light to reflective optics 40a and 40b. These reflective optics are configured to direct light from an exit aperture of CPC 34b towards sample volume 42. Those of ordinary skill in the art will readily recognize that many different types of reflective optics can be employed. In a particularly preferred exemplary embodiment, reflective optics 40a and 40b are implemented as a pair of concave reflective surfaces of hyperbolic and elliptical shape, collectively referred to as a clamshell reflector. Light emitted from biological aerosols entrained in a flow of fluid passing through sample volume 42 is received by reflective optics 40a and 40b, and is then directed to CPC 34b, which converts the light into a slowly diverging beam that passes through beam splitter 38, and an emitter filter 44. From the emitter filter, the light is directed into a conical reflector 46 that condenses the light and then passes it to a detector 48. Preferably, light source 32 is implemented as an LED emitting a wavelength of light selected to stimulate fluorescence of biological aerosols. The flow of fluid through sample volume 42 will be generally orthogonal to the plane of the drawing sheet, although it should be recognized that if desired, the sample volume can be configured such that the flow of fluid through the sample volume would move from a top portion of the drawing sheet to a bottom portion of the drawing sheet, generally between reflective optics 40a and 40b.

FIG. 6 schematically illustrates how the portion of the optical biological aerosol detector of FIG. 5 including the non-imaging optical components can be implemented using injection molding techniques. An injection molded body 50 includes internal volumes defining sample volume 42, reflective optics 40a and 40b, CPC 34b, CPC 34a (only a portion of which is shown in the Figure), conical reflector 46, and openings configured to accommodate beam splitter 38, and filters 36 and 44. It should be recognized that injection molded body 50 can be fabricated as a single unit, but is more preferably formed in two or more pieces, so that once the body is formed, the filters and beam splitter can be placed in position before the different injection molded pieces are coupled together to form injection molded body 50.

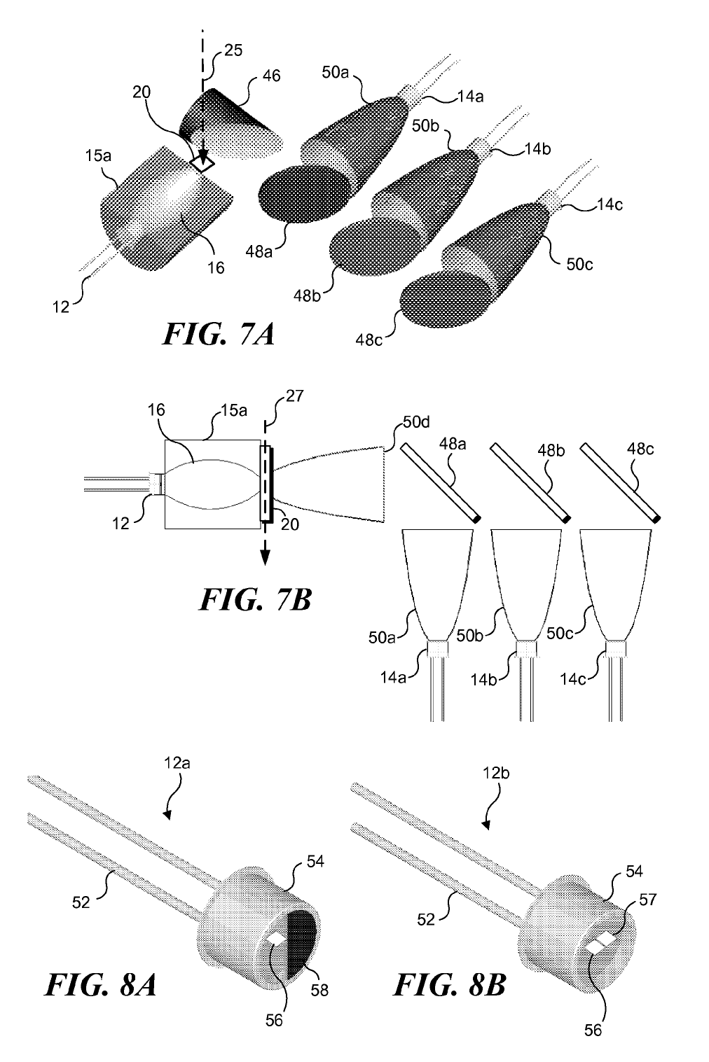

FIG. 7A is an isometric view of a third exemplary embodiment of an optical biological aerosol detector based on the use of non-imaging optical components. Such an embodiment includes light source 12 and non-imaging optical component 16 (generally as described above, and preferably implemented as an injection molded component including a housing 15a), configured to direct light from the light source to sample volume 20 (preferably configured to facilitate a flow of fluid as indicated by an arrow 25). An off-axis parabolic mirror 46 directs light emitted by biological aerosols that are supported by sample volume 20 towards wavelength selective beam splitters 48a, 48b, and 48c. As those of ordinary skill in the art will readily recognize, the wavelength selective beam splitters are configured to allow certain wavelengths of light different than a selected wavelength to pass through the beam splitter, while light of the selected wavelength is directed along an optical path leading to a detector configured to respond to the light of the selected wavelength. Dichroic beam splitters can be employed, although those of ordinary skill in the art will recognize that other types of wavelength selective optical components can alternatively be beneficially employed.

Beam splitter 48a is configured to direct light having an appropriate first wavelength towards a CPC 50a, which in turn, directs that light of the first wavelength to a detector 14a. Similarly, beam splitter 48b is configured to direct light having an appropriate second wavelength towards a CPC 50b, which in turn, directs that light of the second wavelength to a detector 14b, and beam splitter 48c is configured to direct light having an appropriate third wavelength towards a CPC 50c, which in turn, directs that light of the third wavelength to a detector 14c. In a particularly preferred embodiment, detector 14a is configured to be responsive to wavelengths associated with the bio-fluorescence of tryptophan, detector 14b is configured to be responsive to wavelengths associated with the bio-fluorescence of NADH, and detector 14c is configured to be responsive to wavelengths of light that can be used to generate a scatter signal.

While not specifically shown, it should be recognized that non-imaging optical component 16, off-axis parabolic mirror 46, CPC 50a, CPC 50b, and CPC 50c can be implemented as one or more injection molded components, generally as described above with respect to FIG. 6.

FIG. 7B schematically illustrates a related exemplary embodiment of an optical biological aerosol detector, in which the off-axis parabolic mirror of the optical biological aerosol detector of FIG. 7A is replaced with a CPC 50d, and the relative positions of beam splitters 48a, 48b, 48c, CPC 50a, CPC 50b, CPC 50c, detector 14a, detector 14b, and detector 14c have been shifted orthogonally to accommodate receiving light emitted from biological aerosols that is directed along optical path provided by CPC 50d (which is orthogonal to the optical path provided by the off-axis parabolic mirror of FIG. 7A).

Again, it should be recognized that non-imaging optical component 16, CPC 50d (replacing off-axis parabolic mirror 46 of FIG. 7A), CPC 50a, CPC 50b, and CPC 50c can be implemented as one or more injection molded components, generally as described above, with respect to the embodiment of FIG. 6. Sample volume 20 is preferably configured to facilitate a flow of fluid as indicated by an arrow 27, although it should be recognized that the sample volume can instead be readily configured to accommodate a flow of fluid substantially orthogonal to the drawing sheet, generally as discussed above.

FIGS. 8A and 8B schematically illustrate LED packages that can be used as a light source for the optical aerosol detectors disclosed herein. Several novel modifications to conventional LEDs can be implemented. For example, FIG. 8A illustrates an LED light source 12a incorporating a filter 58 (only a portion of which is shown) in an LED metal can package 54, which includes electrical leads 52 and an LED 56. Incorporating filter 58 into a prepackaged LED can eliminate the need to incorporate a filter in another portion of the apparatus, thereby reducing the number of overall parts included in the apparatus. Such filters can be used to clean up the source spectrally. In at least one exemplary embodiment, the filter incorporated in the LED light source housing or package is a UG 11 filter, although those of ordinary skill in the art will readily recognize that other types of filters can be beneficially employed.

FIG. 8B illustrates an LED light source 12b in which two different LEDs, each having a different characteristic wavelength, are encompassed in the same housing. Thus, LED metal can package 54 includes an LED light source 12b comprising both LED 56 and an LED 57, where each different LED emits light having a different characteristic wavelength. Such a configuration will enable a single, relatively low-cost light source to be employed to stimulate bio-fluorescence of tryptophan and bio-fluorescence of NADH. Such a light source is particularly well-suited for the embodiments illustrated in FIGS. 7A and 7B. It should be noted that only one light source will be energized at a time, since the wavelengths corresponding to the autofluorescence from tryptophan overlap with the wavelengths from the light source for stimulating NADH. Preferably, light sources are pulsed in an alternating sequence.

Filters can be used to clean up the light emitted by the light source, and/or to filter out wavelengths of light not required to excite the biological materials to fluoresce. In choosing an exciter filter, historically one has had two basic choices: an interference filter or a colored glass filter. Interference filters are more expensive and require collimated light for proper operation, which can severely hamper imaging and especially non-imaging optical design approaches. Generally, UG-11 colored glass filters can be used with UV-LED light sources as an excitation filter for NADH (for wavelengths of about 340 nm to 375 nm), due to the relatively low cost of such filters. However, to date, there have not been similar glass filters available for implementation of an excited filter for the excitation of tryptophan (requiring a wavelength of about 280 nm). As a result, expensive optical interference filters are generally required for use as excitation filters for tryptophan.

One member of the family of materials potentially suitable for ultra-violet light induced fluorescence excitation of tryptophan is single crystal nickel sulfate hexahydrate. Other candidate materials include ammonium nickel sulfate hexahydrate (ANSH), potassium nickel sulfate hexahydrate (KNSH), cesium nickel sulfate hexahydrate (CNSH), and Rb₂NSH (RNSH). Thus, one aspect of the present disclosure encompasses the use of such materials to achieve an excitation filter configured to stimulate the fluorescence of tryptophan. The significance of these materials can be appreciated when one considers their implementation as a filter. Instead of costly, large diameter interference filters restrictively placed in a collimated beam in the optical train, glass filters coated with such materials can be incorporated into the LED metal package, generally as discussed above. This configuration will result in a much smaller-size filter, and consequently, a comparable reduction in cost.

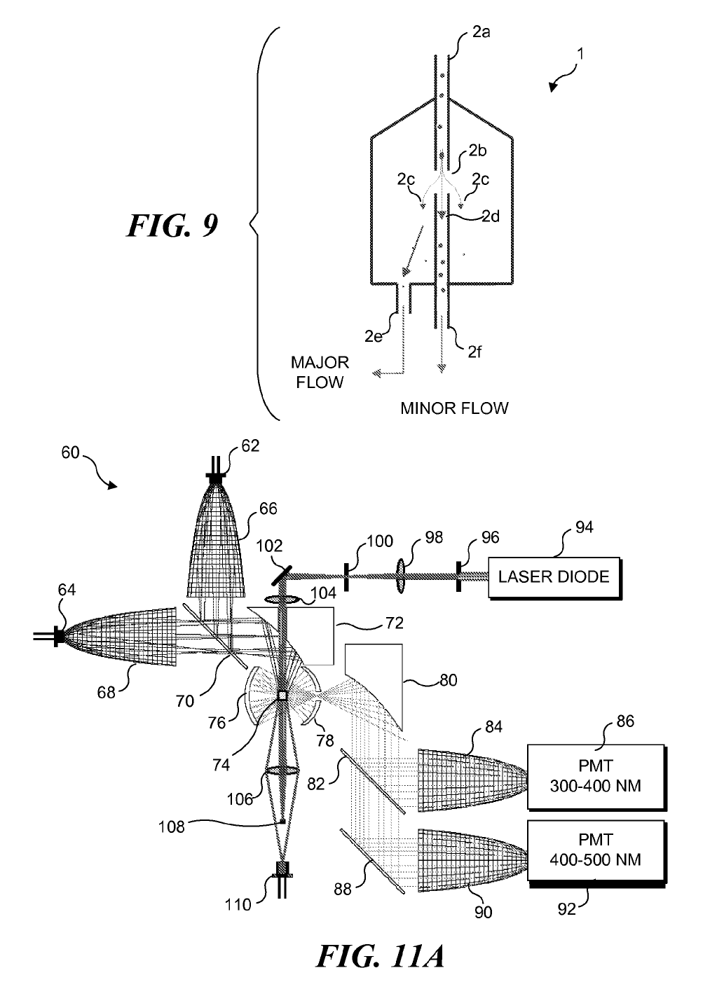

The embodiments discussed above are based on optically detecting the presence of biological aerosols in a sample contained in (or flowing through) a sample volume. Incorporation of additional components will enable biological aerosols to be separated from a gaseous fluid such as air, enabling a pre-concentrated sample of gaseous fluid to be directed into a sample volume for analysis (i.e., for optical detection of biological material contained therein). FIG. 9 is a schematic view of a virtual impactor, which is a component that can be beneficially employed to separate biological aerosols entrained in a flow of gaseous fluid (such as air) from the larger volume of fluid, to produce a volume of fluid in which the biological aerosols are much more concentrated.

Because particulates of interest, such as biological aerosols, are often present in quite small concentrations in a volume of gaseous fluid, it is highly desirable to concentrate the mass of particulates into a smaller volume of gaseous fluid. Virtual impactors can achieve such a concentration without actually removing the particulates of interest from the flow of gaseous fluid. As a result, the particulate-laden gaseous fluid flow can be passed through a series of sequentially connected virtual impactors, so that a gaseous fluid flow exiting the final virtual impactor represents a concentration of particulates 2-3 orders of magnitude greater than in the original gaseous fluid flow. Using a gaseous fluid flow more concentrated with particulates within an optical detector can potentially reduce the time required to analyze an aerosol, and/or improve the detectors' false alarm rate, and/or improve the detector's lower limit of detection.

A virtual impactor uses an aerosol's inertia to separate it from a gaseous fluid stream when the direction of the stream is turned, and a basic virtual impactor can be fabricated from a pair of opposed nozzles. Within a virtual impactor, the intake gaseous fluid coming through the inlet flows out from a nozzle directly at a second opposed nozzle into which only a “minor flow” is allowed to enter. This concept is schematically illustrated by a virtual impactor 1 shown in FIG. 9. Gaseous fluid carrying entrained particulates flows through a first nozzle 2a. The flow from nozzle 2a then passes through a void 2b that is disposed between nozzle 2a and a nozzle 2f. It is in void 2b that the flow of gaseous fluid is divided into a major flow 2c, which contains most of the gaseous fluid (e.g., 90%) carrying aerosols smaller than a cut (predetermined) size, and a minor flow 2d. Minor flow 2d contains a small amount of gaseous fluid (e.g., 10%) in which particulates larger than the cut size are entrained.

As a result of inertia, most of the particulates that are greater than the selected cut size are conveyed in this small minor flow and exit the virtual impactor. Most of the particulates smaller than the virtual impactor cut size are exhausted with the majority of the inlet air, as the major flow. The stopping distance of an aerosol is an important parameter in a virtual impactor design. The cut point (size at which about 50% of the aerosols impact a surface, i.e., flow into the second nozzle) is related to the stopping distance. A 3 micron aerosol has nine times the stopping distance of a 1 micron aerosol of similar density.

For the optical biological detectors described herein, several types of virtual impactors and their variants are suitable for use in collecting samples of biological aerosols as pre-concentrated fluid streams. Because a specific design of the minor flow nozzle can be optimized for a particular size of aerosols, it is contemplated that at least some embodiments disclosed herein may include multiple nozzles, each with a different geometry, so that multiple aerosol types can be efficiently collected. In one preferred embodiment, two virtual impactors are aligned in series, such that a concentration of particulates entrained in the minor flow of gaseous fluid exiting the second virtual impactor is approximately 100 times the original concentration.

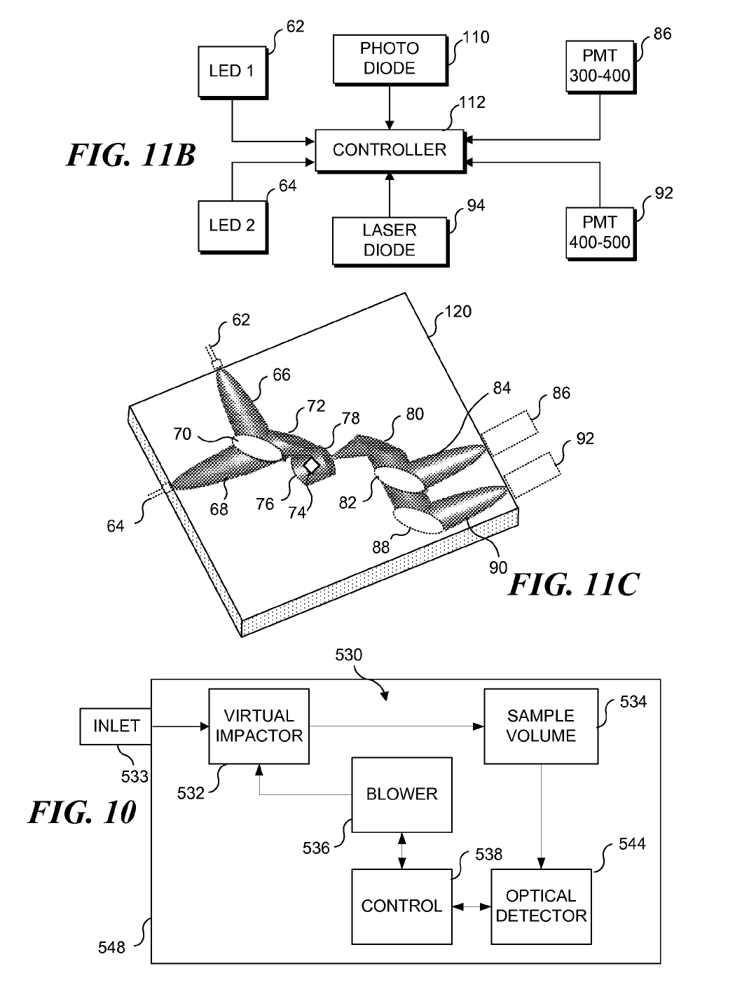

FIG. 10 illustrates an exemplary biological optical detection system 530, for collecting and analyzing particulates entrained in a flow of gaseous fluid to determine if the particles are biological in nature. System 530 includes a gaseous fluid inlet 533 that diverts a portion of a flow of gaseous fluid into system 530. The gaseous fluid inlet preferably includes an inlet pre-filter designed to remove or reject insects, precipitation and over-sized particles. Preferably, a fan 536, which can be centrifugal fan or an axial fan driven by an electric motor or other prime mover (not separately shown), forces gaseous fluid through system 530. It should be noted that the virtual impactors used to separate a flow of gaseous fluid into minor and major flows function best when the gaseous fluid passes through the virtual impactor at about a predefined optimal velocity, which can be calculated or empirically determined. While a source of some gaseous fluid streams may have sufficient velocity to pass through a virtual impactor without requiring a fan to drive them, it is contemplated that many applications of system 530 will generally require such a fan. While as described above, the fan forces a gaseous fluid into system 530, those of ordinary skill in the art will recognize that the fan could alternatively be positioned to draw gaseous fluid through system 530, so that the major flow through system 530 is drawn through an exhaust (also not shown) and the gaseous fluid comprising the minor flow (after the particulates are deposited on the sample substrate), exits through another port (not shown).

System 530 also includes a virtual impactor 532 adapted to separate the gaseous fluid into a major flow and a minor flow that includes particulates of a desired size range that are directed into a sample volume 534. A gaseous fluid is forced into virtual impactor 532 by the fan, and as described above, that gaseous fluid is separated into both a major flow and a minor flow. The major flow is directed to the exhaust, while the minor flow is directed to sample volume 534.

An optical biological aerosol detector 544 (generally consistent with those described above) is included, to analyze particulates/aerosols directed into the sample volume, to determine if the aerosols are biological in nature. Significantly, such optical detectors can detect the presence of biological particles in flow, such that a solid or liquid sample does not need to be collected, in contrast to many other types of detectors.

In many applications, it will be important that the system be able to sample a large volumetric flow of air (e.g., greater than 300 lpm). To achieve this goal, it will be important to achieve the separation of particulates from a large air volume and their concentration in a relatively smaller air volume (i.e., the minor flow). In such applications, it is contemplated that two serial in-line stages of virtual impaction may be preferable. In the first stage, 90% of the inlet gaseous fluid is discarded, and the remaining 10% of the gaseous fluid (1^{st} stage minor flow) contains the desired aerosols. This first stage minor flow then enters a second virtual impactor stage with 90% of gaseous fluid that enters the second stage being exhausted. Therefore, the two stages have the combined effect of concentrating the outlet minor gaseous fluid volume to 1/100^{th} of the initial inlet flow volume. This relatively small minor flow should then be in the correct range for direction into the sample volume.

Referring now to the optical biological aerosol detectors described above, it should be recognized that while specific reflector shapes have been discussed, other shapes may instead be used, including but not limited to shapes having parabolic, spherical, or flat surfaces. In addition, similar functionality can be achieved via refractive lens components. These different types of optical components (reflective and refractive) can also be used in the same system.

Various permutations of the optical layouts discussed above are to be considered to be encompassed within the scope of the novel concepts disclosed herein. For instance, the clamshell imaging component may not be included for some applications, or the conical reflector employed in some embodiments described above could be replaced with a CPC. While some embodiments discussed above measure samples in reflection, it should be recognized that other geometries are also acceptable, such as measuring samples in transmission.

FIG. 1A schematically illustrates yet another particularly preferred embodiment of an optical bioaerosol detector 60, based on the use of non-imaging optical components. Detector 60 includes an LED 62 configured to stimulate bio-fluorescence of tryptophan and a first CPC 66 disposed adjacent to the first LED; CPC 66 is configured to direct light away from the first LED. LED 62 can be implemented using an ultraviolet (UV) LED emitting light having a wavelength of approximately 280 nm. Detector 60 also includes a second LED 64 configured to stimulate bio-fluorescence of NADH, and a second CPC 68 disposed adjacent to LED 64; CPC 68 is configured to direct light away from the second LED. A beam splitter 70 is disposed to direct light emitted from the exit apertures of CPC 66 and CPC 68 toward an off-axis parabolic mirror 72, which in turn, directs light from LED 62 and LED 64 to a sample volume 74. LED 64 can be implemented using a UV LED emitting light having a wavelength of approximately 365 nm.

Sample volume 74 is disposed between reflectors 76 and 78 (generally as described above and referred to as a clamshell reflector or clamshell imager). As described above, light from the LEDs stimulates bio-fluorescence of NADH and tryptophan naturally present in biological material. In this exemplary embodiment, sample volume 74 is configured to receive a flow of fluid substantially orthogonal to the drawing sheet. Fluorescence light from such biological materials is directed out of the clamshell reflector and generally toward an off-axis parabolic mirror 80. The fluorescence light is directed toward a beam splitter 82 (preferably implemented with a dichroic filter). Generally as described above, light of appropriate wavelengths (preferably light having wavelengths ranging from about 300 nm-400 nm) is reflected by beam splitter 82 toward an entrance aperture of a CPC 84. A detector 86 is disposed at the exit aperture of CPC 84. In a particularly preferred embodiment, detector 86 is a photomultiplier tube configured to respond to light having a wavelength of between about 300 nm and 400 nm.

Fluorescence light that passes through beam splitter 82 is then directed to a beam splitter 88 (also, for example, implemented with a dichroic filter). Light of appropriate wavelengths (preferably light having wavelengths ranging from about 400 nm-500 nm) is reflected by beam splitter 88 toward an entrance aperture of a CPC 90. A detector 92 is disposed at the exit aperture of CPC 90. In one embodiment, detector 92 is a photomultiplier tube configured to respond to light having a wavelength of between about 400 nm and 500 nm. Detectors 86 and 92 are configured to generate signals indicative of fluorescence light associated with the autofluorescence of tryptophan and NADH, and analysis of such signals can be used to determine whether a biological material is present within the fluid passing through sample volume 74.

Detector 60 also includes a laser diode 94 (preferably a laser diode emitting light having a wavelength of about 820 nm), configured to emit light that is filtered by a mask 96, and focused by a lens 98. Focused light passes through an aperture 100, and is directed to a reflector 102, which in turn directs the light through a lens 104 and an opening in off-axis parabolic mirror 72, and towards sample volume 74. Scattered light exits the sample volume and is directed towards a lens 106, a beam stop 108, and a detector 110 (preferably implemented using a photo diode). Detector 110 is configured to generate a scattering signal that can be used for several purposes. The scattering signal can be used to estimate relative sizes of particles passing through the sample volume, such that signals from detectors 86 and 92 can be ignored whenever the signal from detector 110 indicates that the size of the particles lies outside a range that particle detector 60 is optimized to detect (for example, based on the size of biological particles likely to correspond to pollen or paper particles, as opposed to biological toxins) and can be ignored. Furthermore, where laser diode 94 and its optical path are disposed in a plane above the optical paths for the LEDs and bio-fluorescence detectors, the signal from detector 110 can be used to trigger activation of the LED light sources according to a predefined pattern. In this exemplary embodiment, the LEDs are not always energized while the detector is being used. While LEDs are generally relatively long-lived solid-state devices, the UV-LEDs that can be employed in detector 60 are not nearly as long-lived as more conventional visible light LEDs. Thus, energizing the LEDs only when detector 110 indicates that aerosol particles are passing through the sample volume increases the operational lifespan of the LEDs and also reduces the overall power consumption of the detector. Furthermore, in some sampling paradigms, it will be preferable for each LED to be separately selectively energized, so that the autofluorescence of tryptophan and NADH are not simultaneously stimulated. This technique is particularly useful because the light emitted by the autofluorescence of tryptophan and the autofluorescence of NADH share some wavelengths, and separating the autofluorescence phenomenon in time enables the signals collected by detectors 86 and 92 to be more closely correlated with the autofluorescence of either tryptophan or NADH. In an exemplary, but not limiting embodiment, residence time of a particle in the sample volume is about 10⁻⁴ to about 10⁻³¹ seconds.

FIG. 11B is a functional block diagram illustrating how a controller is logically coupled to various components of the optical bioaerosol detector of FIG. 11A. As noted above, the LEDs are preferably energized according to a predefined protocol. A controller 112 can be incorporated into detector 60 and logically coupled to each LED light source, laser diode 94, and detectors 86, 90, and 110. The controller can be implemented as a hardware controller (such as an application-specific integrated circuit) or as a software-based controller (i.e., a computing device including a processor that executes machine instructions stored in a memory to carry out control functions).

FIG. 11C schematically illustrates how a portion of the optical bioaerosol detector of FIG. 11A, including non-imaging optical components, can be implemented as a monolithic structure suitable for fabrication using injection molding techniques, generally as described above.

FIG. 12 schematically illustrates yet another embodiment of an optical bioaerosol detector 130 based on the use of non-imaging optical components, which includes two primary components including monolithic structures, an illumination chamber component and a detection flower component. Detector 130 is generally enclosed within a housing 132. A gaseous fluid (such as air) possibly including biological materials, is drawn into the housing via an inlet 134. A vacuum pump 152 (or alternatively, a fan) draws air into the unit. While not specifically shown in FIG. 12, the vacuum pump 152 also draws a sheath fluid into the unit, through a replaceable filter 136 (thus, the sheath fluid is generally filtered air). Exemplary ports include a power port 138 (configured to enable detector 130 to be energized by an appropriate electrical power supply), a data port 140 (configured to enable detector 130 to communicate data to an external device, such as a computer; in an exemplary embodiment data port 140 is a universal serial bus port), a network port 142 (configured to enable detector 130 to be linked to a computer network), and a diagnostic interface port 144 (configured to enable detector 130 to be coupled to appropriate diagnostic equipment, to determine if the detector is operating within normal parameters).

As noted above, detector 130 includes two primary components, which in an exemplary embodiment are implemented using monolithic structures. An illumination chamber component 146 can be implemented using two monolithic structures configured to join together in a facing relationship, generally as described above. While a single monolithic structure might be able to be employed, the use of two (or more) monolithic structures will likely result in considerable cost reductions. Illumination chamber component 146 includes multiple light sources, a sample volume, and a fluid path for the sheath flow and the gaseous fluid in which biological particles might be entrained. Generally as discussed above, relatively low cost non-imaging optical components are employed in illumination chamber component 146 to direct light from light sources toward the sample volume.

A detection flower component 148 includes a plurality of detectors, and a plurality of relatively low cost non-imaging optical components, which are employed to direct light from the sample volume in the illumination chamber component 146 toward specific detectors. In an exemplary embodiment, detection flower component 148 is implemented using two monolithic structures, which when joined together in a facing relationship define the detection flower component 148. The term detection flower refers to the floral like arrangement of a plurality of relatively similar petals or branches radiating from a central source.

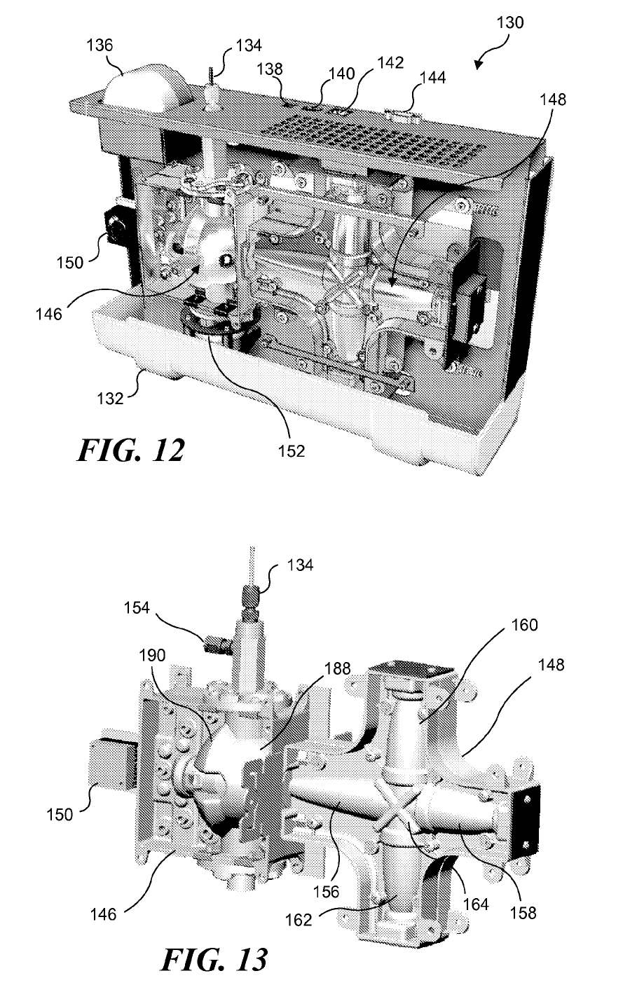

FIG. 13 provides a more detailed view of illumination chamber component 146 and detection flower component 148. A sheath flow inlet port 154 can be seen as part of illumination chamber component 146, as well as a fan 150, configured to provide cooling to one or more light sources used to stimulate fluorescence in biological materials. Preferably, illumination chamber component 146 includes two LED light sources. In a particularly preferred embodiment, one LED emitting light of about 280 nm is employed, along with a second LED emitting light of about 365 nm. Illumination chamber component 146 preferably includes an elliptical reflector 190 and a hemispherical reflector 188, also as generally discussed above. Where injection molding techniques are used to form the opposed monolithic structures preferably employed to implement illumination chamber component 146, a reflective coating can be deposited on the inner surfaces defining elliptical reflector 190 and hemispherical reflector 188. It may not be desirable to coat the entire interior surface of the opposed monolithic structures with a reflective coating, as that may lead to increased levels of stray light reaching the detectors, resulting in increased noise levels. Empirical testing of specific configurations can be used to determine which portions of the opposed monolithic structures should or should not be coated with a reflective material to achieve an optimal signal-to-noise ratio.

Detector flower component 148 includes four branches (or petals). Preferably, each branch includes relatively low cost non-imaging optical components configured to direct light away from the sample volume and toward a detector. In a particularly preferred embodiment, detector flower component 148 is fabricated using two monolithic structures joined together in a facing relationship. Those of ordinary skill in the art will readily recognize that other combinations of monolithic structure can be employed (for example, each branch/petal can be formed as a single monolithic structure, or each branch/petal can be formed of two opposing monolithic structures).

A branch 156 includes a non-imaging optical component configured to direct light from illumination chamber component 146 toward a central core 164 of the detector flower. Optical elements (preferably dichroic filters or other types of beam splitters) in central core 164 direct light along branches 158, 160, and 162. As will be discussed in greater detail below, each branch 158, 160 and 162 includes a detector. Preferably, each branch 158, 160 and 162 also includes a CPC to help direct the light to the detector.

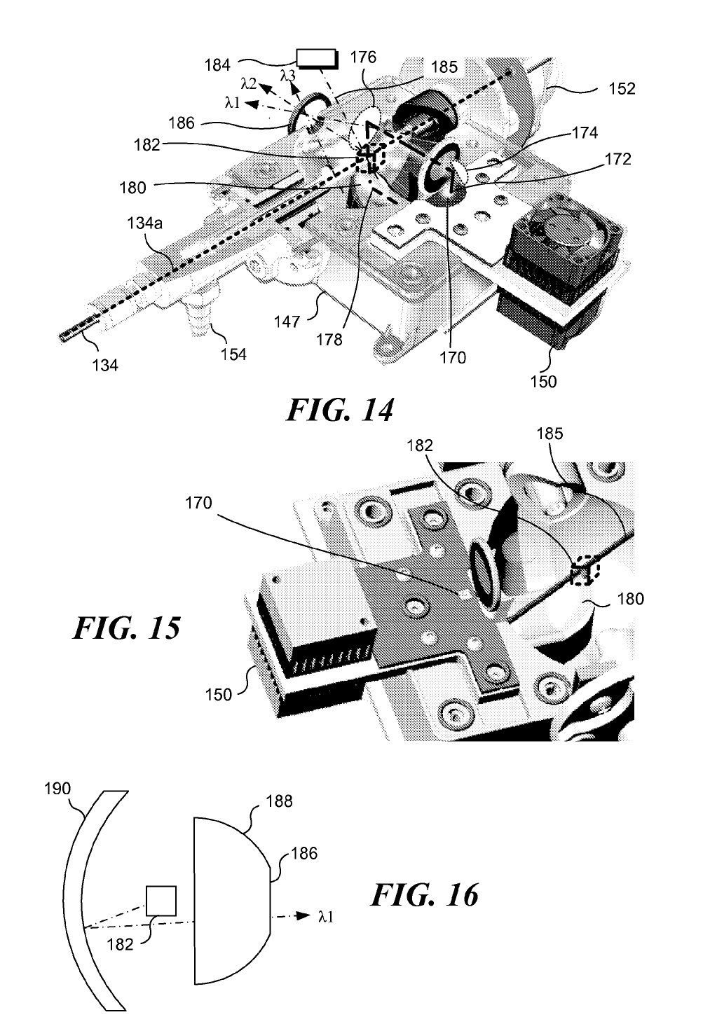

FIGS. 14 and 15 schematically illustrate a first monolithic structure used to implement the illumination chamber component of the optical bioaerosol detector of FIG. 12. A monolithic structure 147 is configured to be joined in a facing relationship with a similar monolithic structure (not separately shown) to define the illumination chamber component, which includes a central illumination chamber that is generally spherical. The illumination chamber is not a perfect sphere, as the illumination chamber, which includes a sample volume 182, is formed by a spherical reflector 188 and an elliptical reflector 190 (see FIGS. 13 and 16). The use of such structures have been generally discussed above. A housing supporting inlet 134 and sheath inlet 154, and vacuum pump 152, are coupled to each opposed monolithic structure defining the illumination chamber component. A fluid path 134a for gaseous fluid (such as air) that may contain biological particles is shown in FIG. 14, noting that fluid path 134a intersects sample volume 182.

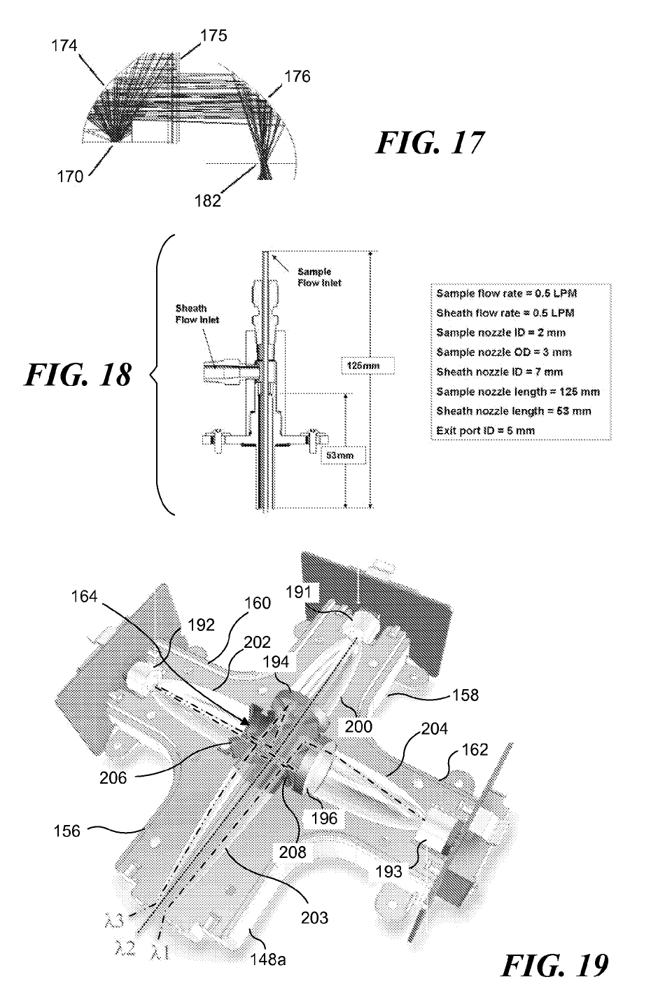

Three different light sources are employed in the illumination chamber component; consistent with the structure shown in FIG. 11B, discussed above. An IR laser diode 184 interrogates the sample volume with a beam 185 on a generally continuous basis. When scattered IR light is received at a detector in the detector flower component, indicating that a particle (possibly a biological particle) has entered the sample volume, an LED 170 is energized. A reflector 174 and a reflector 176 direct a light beam 172 into the sample volume, to induce the particle to fluoresce if the particle is biological (and can be stimulated by the wavelength of light emitted by LED 170). It should be recognized that reflector 174 and reflector 176 will preferably be formed into the monolithic structure disposed in the facing relationship with monolithic structure 147, and thus reflector 174 and reflector 176 are indicated by dash lines. FIG. 17 provides a schematic illustration of an exemplary orientation of an LED light source, two reflectors, and the sample volume.

A second LED (which is hidden from view by monolithic structure 147, but which is disposed generally opposite LED 170) introduces light having a different wavelength into the sample volume. Two reflectors are similarly employed to direct a light beam 178 into the sample volume. Of those two reflectors, only the second (reflector 180) is visible in FIG. 14. Illumination chamber component 146 includes an exit port 186 that enables light of particular interest to escape from the illumination chamber. Three types of light are of particular interest, labeled λ1, λ2, and λ3. Those three types of light will be discussed in greater detail below, in connection with describing the detector flower component. A fan 150 is employed to moderate the temperature of the LEDs. Generally as discussed above, it is preferable to alternate the illumination of the sample volume by the LEDs (that is, preferably the LEDs are not illuminated simultaneously). The system can operate at speeds sufficient to enable each LED to illuminate the sample volume a plurality of times while a particle is transiting the sample volume, even though sample volume 182 is relatively small.

FIG. 15 schematically illustrates monolithic structure 147 from a different angle. It should be recognized that light from laser diode 184, and each LED enter the sample volume with an orientation that is not inline with exit port 186, such that stray light exiting the exit port is minimized. Thus the light exiting the exit port is primarily scattered light and fluorescence from stimulated biological particles.

FIG. 16 schematically illustrates the elliptical and hemispherical reflectors employed in the illumination chamber component of the optical bioaerosol detector of FIG. 12, along with a depiction of a potential beam path (λ1) for light (UV or IR) scattered from an object in sample volume 182.

FIG. 17 schematically illustrates an exemplary technique to introduce light from an LED into a sample volume in the illumination chamber component of the optical bioaerosol detector of FIG. 12. Light is emitted from LED 170 and is directed toward an opening in the illumination chamber by reflector 174 (which reflects the light substantially orthogonal to its original direction). The light is then reflected by reflector 176 (again in a substantially orthogonal direction), to direct the light into sample volume 182. It should be recognized that the light need not be reflected substantially orthogonally, as other configurations are possible which require different angles to enable the light to be directed into the sample volume. Preferably, relatively low cost non-imaging parabolic reflectors are employed.

FIG. 18 schematically illustrates details relating to the introduction of a gaseous fluid potentially including biological particles into the illumination chamber component of the optical bioaerosol detector of FIG. 12. It should be recognized that the dimensions and flow rates of FIG. 18 correspond to a proof of concept working embodiment, and are intended to be exemplary, rather than limiting.

FIG. 19 schematically illustrates a first monolithic structure used to implement the detection flower component of the optical bioaerosol detector of FIG. 12. In an exemplary embodiment, detector flower component 148 is implemented using opposed monolithic structures, which when joined together in a facing relationship achieve the desired structure. One such monolithic structure 148a is schematically illustrated in FIG. 19. Monolithic structure 148a includes portions corresponding to branches 156, 158, 160 and 162. Branch 156 includes a non-imaging optical component 203 configured to direct light passing from sample volume 182 in the illumination chamber through exit port 186 toward a filter 206 disposed in central core 164 (note that a filter 208 is not required, and simply represents an optional location/orientation for filter 206, which would result in switching the paths of light beams λ1 and λ3). Filter 206 directs light along each of branches 158, 160 and 162, toward detectors 191, 192, and 193. Note that branches 158, 160 and 162 preferably respectively include CPCs 200, 202, and 204. Additional filters 194 and 196 are employed to ensure that light of a specific waveband reaches a particular detector.

Light designated λ1 corresponds to UV fluorescence, which is substantially reflected by filter 206 into CPC 204 to detector 193. Filter 196 is used to prevent stray light (i.e., scattered IR, scattered UV having a different wavelength than the wavelength detector 193 is configured to detect, and UV fluorescence having a different wavelength than the wavelength detector 193 is configured to detect). UV fluorescence corresponds to light emitted from a stimulated biological particle, and can be used to determine if biological materials are in the sample volume.

Light designated λ2 corresponds to UV fluorescence (having a different wavelength that the UV fluorescence directed into branch 162 toward detector 193), which substantially passes through filter 206, and moves through CPC 200 to detector 191. Filter 194 can be employed to prevent stray light (i.e., scattered IR, scattered UV having a different wavelength than the wavelength detector 191 is configured to detect, and UV fluorescence having a different wavelength than the wavelength detector 191 is configured to detect). Having multiple UV fluorescence signals enables additional information about specific biological particles to be determined.

Light designated λ3 corresponds to both IR scatter and UV scatter (UV light from the LEDs, as opposed to UV fluorescence emitted from biological particles). Filter 206 acts as a beam splitter for IR scatter and UV scatter, such that a portion of the light designated λ2 (i.e., about 50%) passes through filter 206 and moves toward filter 194, which has been selected to reflect IR scatter and UV scatter, while passing fluorescence of desired range of wavelengths (which correspond to wavelengths detector 191 is configured to detect). When the portion of light designated λ2 that is reflected by filter 194 reaches filter 206, a portion of that light is reflected by filter 206 toward CPC 202 and detector 192. When the light designated λ2 initially encounters filter 206, the portion that does not pass through filter 206 (and moves toward filter 194) is reflected by filter 206, and thus directed to filter 196, which has been selected to reflect IR scatter and UV scatter, while passing fluorescence of desired range of wavelengths (which correspond to wavelengths detector 193 is configured to detect). When the portion of light designated λ2 that is reflected by filter 196 reaches filter 206, a portion of that light passes through filter 206 and moves through CPC 202 and toward detector 192. In the detector flower, IR side scatter is used to detect when a particle (which could be biological) enters the sample volume. UV scatter information can be used to help determine sizing of particles in the sample volume.

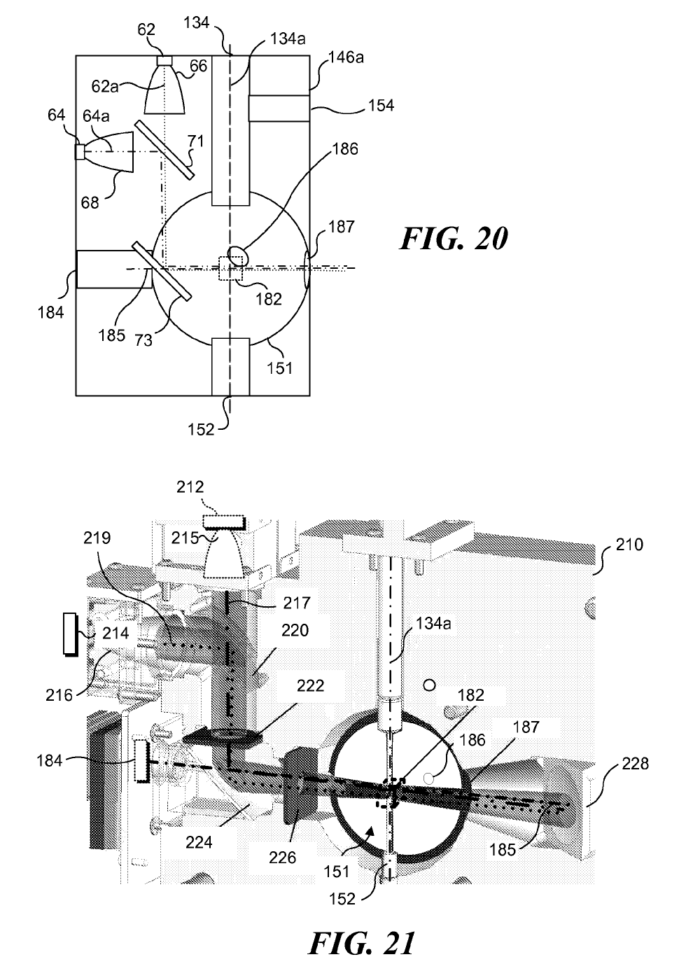

FIG. 20 schematically illustrates an illumination chamber component 146a configuration in which a reflector directing light from light sources into an illumination chamber 151 is partially disposed within the illumination chamber. The illumination chamber, consistent with the use of term in connection with FIG. 14, refers to a chamber containing the sample volume, defined primarily by the hemispherical and elliptical reflectors of FIG. 16. The gaseous fluid potentially containing biological materials, the filtered sheath fluid, and light from the IR trigger and the UV LEDs are all directed into the illumination chamber. As discussed above, all or portions of illumination chamber component 146a can be implemented using monolithic structures joined together in a facing relationship. In some embodiments, the LEDs and their non-optical imaging components are part of such monolithic structures, while in other embodiments the LEDs and their non-optical imaging components are implemented as separate structures that are attached to the monolithic structures once they are joined (or as they are joined).

Generally as described above, illumination chamber component 146a includes gaseous fluid inlet 134, sheath inlet 154, and vacuum pump 152, which cooperate to direct gaseous fluid 134a into sample volume 182. Also as generally described above, illumination chamber component 146a includes exit port 186, through which light of particular interest is directed toward detection components.

Illumination chamber component 146a includes LED 62 and CPC 66, which direct a light beam 62a through a beam combining reflector 71 toward a reflector 73, which directs light beam 62a toward sample volume 182. CPC 66 can be replaced by a parabolic reflector.

Illumination chamber component 146a includes LED 64 and CPC 68, which direct a light beam 64a toward beam combining reflector 71, which redirects light beam 64a toward reflector 73, which directs light beam 64a toward sample volume 182. CPC 68 can be replaced by a parabolic reflector.

Illumination chamber component 146a includes laser diode 184 (i.e., an IR laser source), which emits light beam 185 through reflector 73 toward sample volume 182. If the reflector is not transparent to IR wavelengths, an opening (not separately shown) can be formed into reflector 73 to enable IR light beam 185 to reach sample volume 182.

Illumination chamber component 146a also includes exit port 187, which serves several functions, including providing a beam dump for un-scattered IR and un-scattered UV (from LEDs 62 and 64). In some embodiments, exit port 187 also enables collection of forward particle (IR) scattering by a forward scatter mirror and detector (neither of which are separately shown). Note that in embodiments that include a forward scatter mirror and detector, the IR side-scatter is not required to be collected in the detection flower (i.e., the forward scatter is used to trigger the LEDs, not the side-scatter).

Note that a portion of reflector 73 intrudes into illumination chamber 151. Empirical testing of this configuration indicates that having reflector 73 protrude into the illumination chamber appears to cause unintentional scattering of both UV and IR light. The unintentionally scattered light exits the illumination chamber along with light of particular interest via exit port 186, and thus the unintentionally scattered light reaches the detectors and is responsible for undesirable levels of noise. Note that light scattered from particles in the sample volume is light of particular interest. However, light scattered by reflector 73 is not, and simply represents noise.

FIG. 21 schematically illustrates an illumination chamber component 210 configuration in which no elements related to directing light from light sources into the illumination chamber are disposed within the illumination chamber, minimizing noise from stray light.

Generally as described above, illumination chamber component 210 includes a gaseous fluid inlet 134, sheath inlet 154 (not shown), and vacuum pump 152 (only a portion of which is shown), which cooperate to direct gaseous fluid 134a into sample volume 182. Also as generally described above, illumination chamber component 146a includes exit port 186, through which light of particular interest is directed toward detection components (such as a detection flower, or the detection elements of FIGS. 7A, 7B, 10, 11A, and 11B).

Illumination chamber component 210 includes an LED 212 and a parabolic reflector 215, which directs a light beam 217 through a filter 220 toward a reflector 224, which directs light beam 217 toward sample volume 182. Preferably, reflector 215 is not a CPC.

Illumination chamber component 210 includes LED 214 and a parabolic reflector 216, which directs a light beam 219 toward filter 220, which redirects light beam 219 toward reflector 224, which directs light beam 219 toward sample volume 182. Preferably, reflector 216 is not a CPC.

Illumination chamber component 210 includes laser diode 184 (i.e., an IR laser source), which emits light beam 185 through reflector 224 toward sample volume 182. If the reflector is not transparent to IR wavelengths, an opening (not separately shown) can be formed into reflector 224 to enable IR light beam 185 to reach sample volume 182.

Illumination chamber component 210 also includes exit port 187, which serves several functions, including providing a beam dump for un-scattered IR and un-scattered UV (from LEDs 212 and 214). In this embodiments, exit port 187 also enables collection of forward particle (IR) scattering by a forward scatter mirror 228 and a detector (not separately shown).

Note that no portion of filter 224, nor any other element employed to direct light into the sample volume, intrudes into illumination chamber 151, which will reduce the amount of unintentionally scattered light reaching the UV scatter and fluorescence detectors, thereby reducing noise.

Additional noteworthy changes include employing a relatively long focal length mirror for reflector 224, which will minimize beam divergence of the light from the LEDs. A primary aperture screen 220 blocks stray light from the LEDs, and a secondary aperture screen 226 blocks scattered light.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. Apparatus for optically detecting a biological material entrained in a gaseous fluid, comprising:
(a) a sample volume configured to receive a gaseous fluid in which biological materials may be entrained;
(b) a light source configured to stimulate a biological material to emit light;
(c) a first non-imaging optical component configured to direct light from the light source toward the sample volume;
(d) a detector configured to detect the light emitted from the biological material; and
(e) a second non-imaging optical component configured to direct light emitted from the biological material toward the detector.

2. The apparatus of claim 1, wherein at least one of at least a portion of the first non-imaging optical component and at least a portion of the second non-imaging optical component is implemented as a monolithic structure.

3. The apparatus of claim 2, wherein each monolithic structure is fabricated using injection molding techniques.

4. The apparatus of claim 1, wherein each monolithic structure comprises a polymer, with the portions of the monolithic structure corresponding to one of the first non-imaging optical component and the second non-imaging optical component being coated with a reflective material.

5. The apparatus of claim 1, wherein the light source comprises a light emitting diode including an integral light filter.

6. The apparatus of claim 1, wherein at least one of the first non-imaging optical component and the second non-imaging optical component comprises a compound parabolic collector.

7. The apparatus of claim 1, further comprising an additional detector and an additional non-imaging optical component, the additional non-imaging optical component configured to direct light emitted from the biological material toward the additional detector.

8. The apparatus of claim 1, wherein at least one of the first and second non-imaging optical components comprises two compound parabolic collectors.

9. The apparatus of claim 1, further comprising at least one reflective element disposed between the sample volume and the detector.

10. The apparatus of claim 11, further comprising at least one of:
(a) a virtual impactor capable of separating the gaseous fluid into a major flow and a minor flow, the major flow including a minor portion of particulates that are above a predetermined size and the minor flow including a major portion of the particulates that are above the predetermined size, the virtual impactor including a minor flow outlet through which the minor flow exits the virtual impactor, such that the minor flow is directed into the sample volume; and
(b) an inlet pre-filter configured to remove or reject over-sized particles, insects, precipitation and other airborne debris from the gaseous fluid before the gaseous fluid is introduced into the sample volume.

11. The apparatus of claim 10, wherein at least a portion of the first non-imaging optical component and at least a portion of the second non-imaging optical component are implemented as a single monolithic structure.

12. The apparatus of claim 1, wherein at least one of the first and second non-imaging optical components comprises:
(a) a first monolithic structure incorporating a plurality of first surface features; and
(b) a second monolithic structure incorporating a plurality of second surface features, such that when the first monolithic structure and the second monolithic structure are disposed in a facing relationship, the plurality of the first surface features and the plurality of second surface features defining the corresponding one of the first and second non-imaging optical components.

13. The apparatus of claim 18, wherein the first monolithic optical structure incorporates a plurality of third surface features, and the second monolithic optical structure incorporates a plurality of fourth surface features, such that when the first monolithic optical structure and the second monolithic optical structure are disposed in a facing relationship, the plurality of third surface features and the plurality of fourth surface features cooperate to provide support for at least one additional optical component.

14. The apparatus of claim 13, wherein the at least one additional component comprises at least one of a dichroic filter, an excitation filter, and an emitter filter.

15. The apparatus of claim 10, wherein the light source comprises a light emitting diode (LED) configured to stimulate a first type of bio-fluorescence of biological materials, where the first type of bio-fluorescence has a first characteristic wavelength, and the detector is configured to detect the first characteristic wavelength.

16. The apparatus of claim 15, further comprising:
(a) a second LED configured to stimulate a second type of bio-fluorescence of biological materials, where the second type of bio-fluorescence has a second characteristic wavelength;
(b) a third non-imaging optical component disposed adjacent to the second LED, the third non-imaging optical component being configured to direct light toward the sample volume;
(c) an additional detector configured to detect the second characteristic wavelength; and
(d) a fourth non-imaging optical component disposed adjacent to the additional detector, the fourth non-imaging optical component being configured to direct light toward the additional detector.

17. The apparatus of claim 16, wherein the first LED is configured to stimulate bio-fluorescence of tryptophan and the second LED is configured to stimulate bio-fluorescence of nicotinamide adenine dinucleotide (NADH).

18. The apparatus of claim 17, wherein the second and fourth non-imaging optical component are implemented together in a monolithic structure.

19. The apparatus of claim 18, wherein the second and fourth non-imaging optical components are implemented using two different monolithic structures, which when joined in a facing relationship define the second and fourth non-imaging optical components.

20. A method for optically detecting the presence of a biological material in a sample, comprising the steps of:
(a) directing light away from a light source configured to stimulate a biological material in the sample to emit light, using a first non-imaging optical component;
(b) using the light directed away from the light source to illuminate the biological material, thereby stimulating the biological material to emit light;
(c) directing light emitted from the biological material away from the sample using a second non-imaging optical component;
(d) receiving the light emitted from the biological material and directed away from the sample at a detector; and
(e) analyzing the light received by the detector, to detect the presence of the biological material in the sample.

21. The method of claim 20, wherein at least one of the step of directing light away from the light source and of the step of directing light emitted from the biological material away from the sample comprises the step of using a compound parabolic collector to direct the light.

22. The method of claim 20, further comprising the steps of:
(a) using a virtual impactor to separate a gaseous fluid flow in which biological material are entrained into a major flow that includes a minor portion of biological material above a predetermined size and a minor flow that includes a major portion of the biological material above the predetermined size; and
(b) directing the minor flow into a sample volume, such that biological material entrained in the minor flow can be detected.

23. The method of claim 20, further comprising the step of using an inlet pre-filter to remove or reject over-sized particles, insects, precipitation and other airborne debris from a gaseous fluid flow in which biological materials are entrained before the gaseous fluid flow is directed into a sample volume.

24. The method of claim 23, further comprising the step of providing a monolithic optical structure comprising at least a portion of the first non-imaging optical component and at least a portion of the second non-imaging optical component.

25. The method of claim 23, wherein the step of directing light away from a light source comprises the step of directing light away from a light emitting diode comprising the light source.
